(19) United States
(12) Patent Application Publication
(10) Pub. No.: US 2026/0337742 A1
(43) Pub. Date: Oct. 29, 2026

(54) MULTI-SCALE FIBER REINFORCED ALUMINUM MATRIX COMPOSITE BASED ON SOLID-STATE ADDITIVE MANUFACTURING AND PREPARATION METHOD THEREFOR

(71) Applicant: NANJING UNIVERSITY OF AERONAUTICS AND ASTRONAUTICS, Jiangsu (CN)

(72) Inventors: Xunzhong Guo, Jiangsu (CN); Gui Wei, Jiangsu (CN); Yizhou Shen, Jiangsu (CN)

(73) Assignee: NANJING UNIVERSITY OF AERONAUTICS AND ASTRONAUTICS, Jiangsu (CN)

(21) Appl. No.: 19/635,713

(22) Filed: Mar. 31, 2026

(30) Foreign Application Priority Data
Apr. 28, 2025 (CN) 202510545102.X

(51) Int. Cl. C22C 47/20; B23K 20/12; B33Y 10/00; B33Y 40/20; B33Y 70/10; C22C 49/06; C22C 49/14

(52) U.S. Cl. CPC C22C 47/20; B23K 20/1215; B23K 20/122; B33Y 10/00; B33Y 40/20; B33Y 70/10; C22C 49/06; C22C 49/14

(57) ABSTRACT

Disclosed in the present disclosure are a multi-scale fiber reinforced aluminum matrix composite based on solid-state additive manufacturing and a preparation method therefor. The method comprises the following steps: loading a solid square bar into an AFSD apparatus and performing single-pass deposition on a substrate to prepare a “pre-deposited layer”; loading a hollow feedstock rod filled with basalt fibers and performing single-pass deposition again on the pre-deposited layer using the same process parameters; and cutting off the substrate and the underlying pre-deposited layer of an obtained sample, while retaining only the uppermost deposited layer, thereby obtaining the multi-scale basalt fiber reinforced aluminum matrix composite.

### CROSS-REFERENCE TO RELATED APPLICATION

This application claims the priority benefit of China application serial no. 202510545102.X, filed on Apr. 28, 2025. The entirety of the above-mentioned patent application is hereby incorporated by reference herein and made a part of this specification.

### BACKGROUND

### Technical Field

The present disclosure relates to the field of metal matrix composites, and in particular, to a multi-scale fiber reinforced aluminum matrix composite based on solid-state additive manufacturing and a preparation method therefor.

### Description of Related Art

Aluminum matrix composites, due to their combination of light weight, high strength, and good formability, have broad application prospects in fields such as aerospace, rail transit, electronic packaging, and automotive lightweighting. In order to further improve the strength, wear resistance, and thermal stability of aluminum alloys, researchers generally introduce ceramic particles, carbon nanotubes, carbon fibers, silicates, etc., as reinforcements into the aluminum matrix to form a metal matrix composite structure. Among these, multi-scale reinforcement design has become an important trend in recent years for improving comprehensive performance.

Currently, there are two main conventional approaches for achieving multi-scale reinforcement: one is to simultaneously introduce micro-scale and nano-scale reinforcements, achieving multi-scale distribution through methods such as mechanical mixing, powder metallurgy, and stir casting; the other involves pre-processing the initial micro-scale reinforcement into nano-scale via methods such as high-energy ball milling, followed by its composite integration with a matrix. However, the above methods generally have the following disadvantages:
(1) the preparation of raw materials is complex, and nano-reinforcements are costly to produce and exhibit strong agglomeration tendencies, making it difficult to disperse them in the metal matrix;
(2) the process flow is long, and the reinforcements need to be pre-processed into various sizes, resulting in cumbersome operation steps and poor controllability of interface bonding;
(3) high-temperature reactions tend to occur at the interface, especially during preparation by liquid-phase methods, where the reinforcements readily react with aluminum at high temperatures to form brittle phases, adversely affecting the overall performance of the composite.

Furthermore, basalt fiber (BF), as a natural silicate fiber, possesses good high-temperature stability, mechanical strength, and electrical insulation performance, and has gradually emerged as one of the promising reinforcing materials for metal matrix composites in recent years. However, conventional powder metallurgy or casting methods struggle to achieve effective dispersion and structural control of basalt fibers in the metal matrix, and problems such as agglomeration, breakage, or interface debonding are prone to occur during processing, limiting the widespread application of basalt fibers.

The additive friction stir deposition (AFSD) technology is an emerging solid-state additive manufacturing process. It achieves near-net shape forming through frictional heat generation and plastic deformation without melting the material, offering advantages such as low processing temperature, uniform microstructure, and strong controllability of reinforcements. Existing research has shown that AFSD can be used to introduce short-cut basalt fibers or particulate reinforcements, achieving a certain degree of microstructure refinement and mechanical strengthening.

In the prior art, there is no literature or publicly disclosed technique that reveals a composite reinforcement strategy involving the in-situ fragmentation of millimeter-scale continuous reinforcements to form multi-scale distribution during the AFSD process; nor is there any publicly disclosed method for guiding the distribution of reinforcements and improving deposition uniformity by setting a pre-deposited structural layer. Therefore, developing a preparation method that requires no pretreatment of the reinforcement and can achieve micro-nano structural reconstruction during the deposition process has become a key technical issue urgently needing a breakthrough in the field of aluminum matrix composites at present.

### SUMMARY

The objective of the present disclosure is to overcome problems existing in the preparation of current aluminum matrix composites, such as complex pretreatment of reinforcement raw materials, poor fiber dispersibility, weak interface bonding, and uncontrollable microstructure. Therefore, the present disclosure proposes a method for preparing an aluminum matrix composite with a uniform microstructure, excellent performance, and a controllable structure based on the AFSD process. This method involves: directly adding millimeter-scale BF raw materials, which undergo in-situ fragmentation to form a multi-scale reinforced structure during the deposition process; and setting a pre-deposited layer to guide the distribution uniformity of the reinforcement.

To achieve the aforementioned objective, the present disclosure provides the following technical solution.

A preparation method for a multi-scale fiber reinforced aluminum matrix composite based on solid-state additive manufacturing, comprising the following steps:
S1, preparing an aluminum alloy solid square bar, an aluminum alloy hollow square bar, an aluminum alloy substrate of the same material, and short basalt fibers, and subjecting the short basalt fibers to cleaning with distilled water, drying under strong convection at 90 °C, and removal of impurities and dirt for later use;
S2, weighing a certain mass of the basalt fibers and loading them into the hollow square bar in a random orientation manner;
S3, capping the hollow square bar filled with the basalt fibers with small AA6061 stubs to maintain the content of the fibers, followed by vibration to promote dispersion of the fibers;
S4, loading the solid square bar into an AFSD apparatus and performing single-pass deposition on the substrate to prepare a “pre-deposited layer”;
S5, measuring the thickness of the pre-deposited layer and correspondingly raising the initial height of an AFSD tool head;
S6, loading the hollow square bar filled with the basalt fibers and performing single-pass deposition again on the pre-deposited layer using the same process parameters as in S4; and
S7, cutting off the substrate and the underlying pre-deposited layer of a sample obtained in S6, while retaining only the uppermost deposited layer, thereby obtaining the multi-scale basalt fiber reinforced aluminum matrix composite.

This technical solution utilizes the in-situ fracture and fragmentation reconstruction of the basalt fibers under friction and shear during the deposition process, causing the millimeter-scale fibers to naturally transform into a multi-scale reinforced structure. Furthermore, with the setting of the deposited layer, dispersion and uniform fusion are guided.

Further, in S1, the aluminum alloy may be an aluminum alloy of 7xxx, 6xxx, 5xxx, 2xxx, or other series; preferably, the matrix is selected as 6061-T6 aluminum alloy.

Further, in S1, the basalt fibers are short-cut basalt fibers, with a length of 1-3 mm and an average diameter of 10-20 μm, preferably with a length of 3 mm and a diameter of 13 μm.

Further, in S1, a hollow region of the square bar may be cylindrical, cubic, etc., and the volume of the hollow region accounts for 3%-10% of that of the square bar. Preferably, the hollow region is a cylinder with the same height as the square bar, the bottom side length of the square bar is 19.8 mm, and the diameter of the cylindrical hollow region is 6 mm.

Further, in S2, the loading mass of the fibers is calculated according to formula (1), wherein A is a coefficient with a value between 30% and 50%.

m_{fiber}=ρ_{fiber}×ν_{fiber}=ρ_{fiber}×ν_{hollow}×A (1)

Further, in S3, in order to promote the dispersion of the fibers in the bar, in addition to mechanical vibration, methods such as centrifugal dispersion and ultrasonic dispersion can also be adopted.

Further, in S4, the process parameters for the deposition process are a preheating time of 10-20 s, a tool head feeding speed of 40-50 mm/min, a traversing speed of 100-120 mm/min, and a rotating speed of 300-500 rpm. Preferably, the preheating time is 20 s, the tool head feeding speed is 50 mm/min, the traversing speed is 115 mm/min, and the rotating speed is 350 rpm.

Further, in S5, the thickness of the pre-deposited layer is controlled to be between 2 mm and 4 mm.

Further, in S6, based on an obtained single-pass BF/AA6061 composite, multi-pass deposition can be further performed according to a designed path, thereby enabling synchronous integration of the preparation and forming of the novel composite.

### Beneficial Effects

Compared with the prior art, the present disclosure has the following significant technical effects and practical value.
(1) It achieves for the first time the in-situ transformation of the millimeter-scale reinforcement into a multi-scale structure during the AFSD process, avoiding the complex procedures of preparing micro-scale and nano-scale reinforcements in advance required by traditional composites, simplifying the raw material preparation process, and improving the reinforcement efficiency.
(2) By setting the pre-deposited layer, a more compatible interface condition can be provided for the deposition of the composite in terms of both physics and microstructure. This reduces the performance gradient between the materials, and promotes stable plastic flow and uniform fiber distribution during the subsequent deposition process. The uniform reinforcement helps to more effectively transfer loads and hinder plastic deformation, while forming a more consistent and denser microstructure, thereby improving the overall hardness and strength.
(3) The AFSD solid-state deposition process and process parameter design are utilized to avoid interfacial reactions and microstructural defects, achieving good metallurgical bonding between the reinforcement and the aluminum alloy matrix. No obvious brittle phases or oxide reaction layers are observed at the interface.
(4) The mechanical properties of the composite are significantly improved: The prepared composite exhibits a grain size refinement from 5.45 μm to 4.22 μm, and a yield strength improved to 139 MPa (improved by about 49% compared with the sample without AFSD reinforcement), while maintaining excellent elongation, demonstrating a good strength-ductility synergy mechanism.
(5) The process can be popularized and features strong material adaptability: The method does not require altering the configuration of existing AFSD equipment, can be extended and applied to other fiber reinforced aluminum alloy systems, and is suitable for low-cost and high-performance manufacturing of critical load-bearing components in aerospace, rail transit, deep-space structures, and other fields.

### BRIEF DESCRIPTION OF THE DRAWINGS

FIG. 1A to FIG. 1F show micromorphology images of the raw materials used in Example 1 of the present disclosure: (a) a three-dimensional metallographic image (FIG. 1A), (b) an IPF map (FIG. 1B), and (c) a grain size statistical diagram of the AA6061 feedstock rod (FIG. 1C); and (d) a physical object image (FIG. 1D), (e) an SEM image (FIG. 1E), and (f) an EDS spectrum of the black region in the selected area e of the basalt fibers (FIG. 1F).

FIG. 2A to FIG. 2B show schematic diagrams of AFSD preparation processes for composites prepared with/without a pre-deposited layer according to Example 1 of the present disclosure: (a) Case 1 without pre-deposited layer (physical object as S1) (FIG. 2A); and (b) Case 2 with pre-deposited layer (physical object as S2), mainly including: 1: hollow AA6061 feedstock rod; 2: short basalt fibers; 3: stirring tool head; 4: substrate; 5: composite prepared without pre-deposited layer (Case 1); 6: solid square bar; 7: pre-deposited layer; and 8: composite prepared with pre-deposited layer (Case 2) (FIG. 2B).

FIG. 3A to FIG. 3D show metallographic images and SEM images of Case 1 (a-b) (FIG. 3A and FIG. 3B) and Case 2 (c-d) (FIG. 3C and FIG. 3D).

FIG. 4A to FIG. 4L show schematic diagrams of fiber dispersion in Case 2 according to Example 1 of the present disclosure: (a) a physical object image of BF/AA6061 (FIG. 4A); (b) a cross-sectional metallographic image along the dashed line in a (FIG. 4B); (c-g) enlarged metallographic images of black-boxed areas 1-5 in b (FIG. 4C to FIG. 4G); (h) a size proportion diagram of micro-scale fibers (FIG. 4H); and (i-l) an enlarged SEM image and EDS maps of specific elements in boxed area 6 in b (FIG. 4I to FIG. 4L).

FIG. 5A to FIG. 5F show schematic diagrams of fiber/matrix interface bonding in Case 2 according to Example 1 of the present disclosure, where (a) and (c) are HAADF and HRTEM images of the area near the BF/Al interface, respectively (FIG. 5A and FIG. 5C); (b) is a BF-STEM image of the boxed area in a (FIG. 5B); (d) is an enlarged view of the boxed area in c (FIG. 5D); and (e) and (f) are EDS spectra obtained by scanning along line 1 and line 2 in a, respectively, with the marked region in f showing EDS results obtained by scanning along line 3 in b (FIG. 5E and FIG. 5F).

FIG. 6A to FIG. 6H show schematic diagrams of multi-scale fiber distribution in Case 2 according to Example 1 of the present disclosure: (a) a local HAADF image of BF/AA6061 (FIG. 6A); (b) a DF-STEM image of the boxed area in a (FIG. 6B); and (c-h) EDS maps of specific elements corresponding to a (FIG. 6C to FIG. 6H).

FIG. 7A to FIG. 7B show hardness and tensile property diagrams of Case 1 and Case 2.

FIG. 8A to FIG. 8D show tensile fracture images of Case 1 (a-b) (FIG. 8A and FIG. 8B) and Case 2 (c-d) (FIG. 8C and FIG. 8D).

FIG. 9 shows a comparison diagram of tensile properties between Case 2 according to Example 1 of the present disclosure and other 6061 aluminum alloy composites prepared by similar processes.

### DESCRIPTION OF THE EMBODIMENTS

The present disclosure will be described in detail below with reference to specific examples.

### Example 1

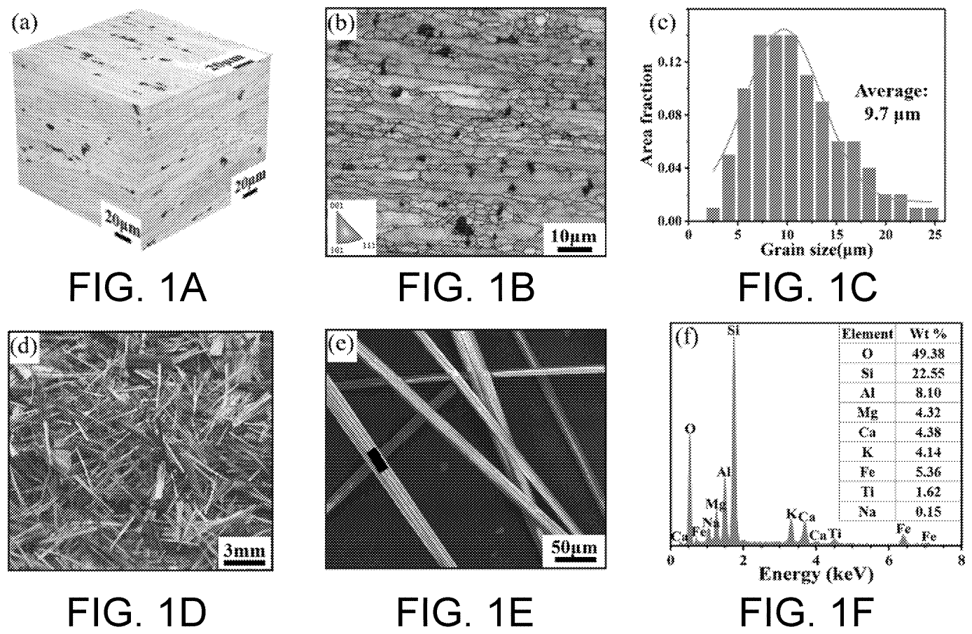

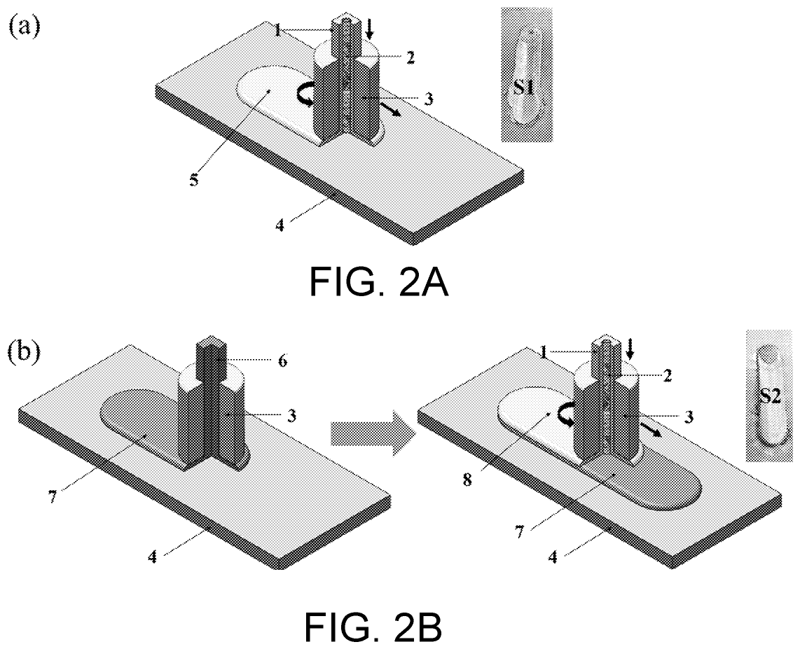

This example provides a method for preparing a multi-scale basalt fiber reinforced 6061 aluminum matrix composite based on the AFSD technology, specifically comprising the following steps:
S1: A 6061-T6 aluminum alloy substrate 4 (with dimensions of 200 mm×400 mm×20 mm) and a 6061-T6 aluminum alloy solid square bar 6 (with dimensions of 19.8 mm×19.8 mm×150 mm) were prepared, and then part of the solid square bar 6 was processed into an internally hollow feedstock rod 1 (the hollow region was a cylinder with a diameter of 6 mm). Short-cut basalt fibers 2 with a length of 3 mm and an average diameter of 13 μm were used as the reinforcement. The basalt fibers were cleaned with distilled water, dried under strong convection at 90 °C, and had impurities and dirt removed for later use. The micromorphologies of the feedstock rod 6 and the original fibers 2 are shown in FIG. 1A-FIG. 1F.
S2: The mass of the fibers to be added was calculated according to a fiber volume fraction of 40% of the hollow region in the bar, meaning that A in formula (1) was set to 40%. The calculated total mass of the fibers to be added was 4.6 g. The above fibers were then loaded into the hollow square bar in a random orientation manner.
S3: The feedstock rod 1 filled with the fibers 2 was capped with small AA6061 stubs to maintain the content of the fibers, and then vibrated on a micro-vibration table (frequency: 100 Hz) for 30 min to promote dispersion of the fibers.
S4: As shown in FIG. 2B, the solid square bar 6 was first loaded into an AFSD apparatus, and single-pass deposition was performed on the substrate with a preheating time of 20 s, a feeding speed of 50 mm/min, a traversing speed of 115 mm/min, and a rotating speed of 350 rpm to prepare a “pre-deposited layer 7”.
S5: The thickness of the pre-deposited layer 7 was measured to be 3 mm, and the initial height of an AFSD tool head 3 was correspondingly raised by 3 mm.
S6: The hollow feedstock rod 1 filled with the basalt fibers 2 was loaded, and single-pass deposition was performed again on the pre-deposited layer 7 using the same process parameters as in S4, thereby obtaining a physical object as shown in FIG. S2.
S7: The substrate 4 and the underlying pre-deposited layer 7 of the sample were cut off, while retaining only the uppermost deposited layer 8, thereby obtaining the BF/AA6061 composite (designated as Case 2).

As a control, a group of BF/AA6061 composites 5 without a pre-deposited layer (designated as Case 1) were also prepared by using the same equipment and process. The preparation process is shown in FIG. 2A, which involved directly subjecting the feedstock rod 1 filled with the fibers 2 to single-pass deposition on the substrate 4, followed by cutting off the substrate 4 to obtain the desired composite.

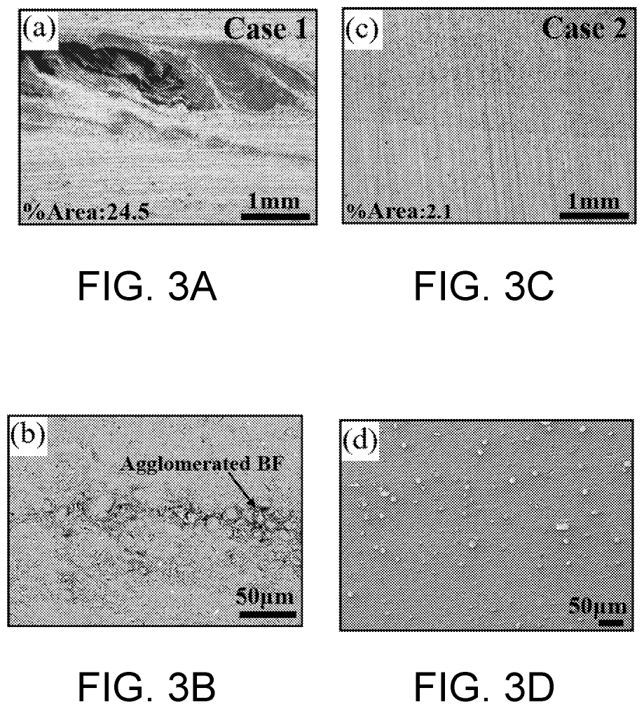

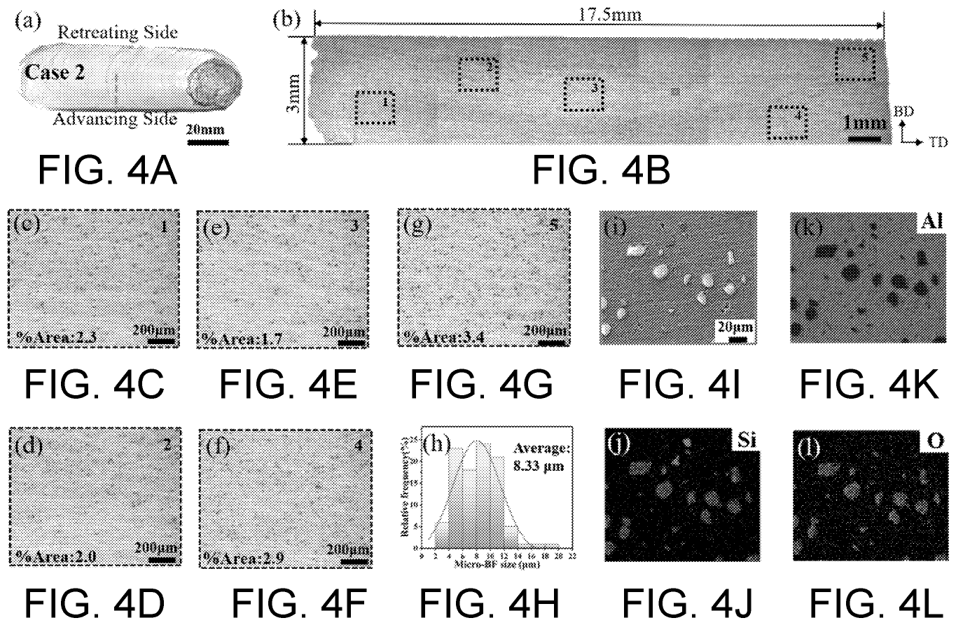

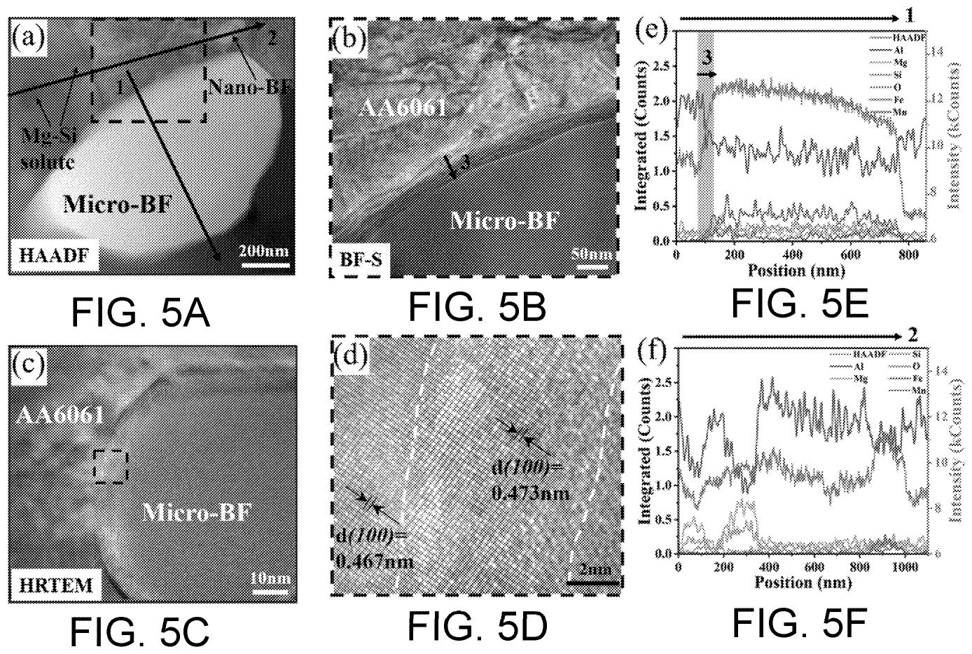

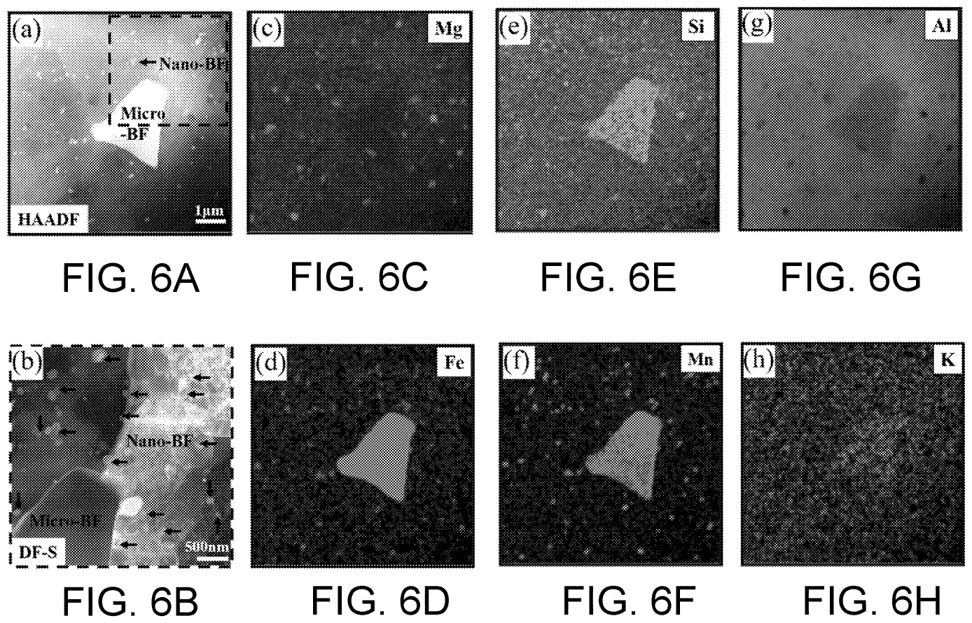

The microstructures and properties of the obtained samples were analyzed, and the results are shown in FIGS. 3-9. It can be seen that compared with the obvious aggregation of the fibers in Case 1, the fiber distribution in Case 2 was more uniform (FIG. 3A-FIG. 3D) and exhibited different orientations, indicating that the pre-deposited layer design could significantly improve the dispersion uniformity of the fibers. To further confirm the dispersion uniformity of the fibers in Case 2, large-area microscopic characterization was performed along the cross-section of Case 2, and it was found that the fibers remained relatively uniformly distributed over a large area (17.5 mm×3 mm) (FIG. 4A-FIG. 4L). The micro-scale fibers were tightly bonded to the Al matrix, with no physical gaps or interfacial reaction products observed, and only elemental diffusion occurred, indicating good metallurgical bonding (FIG. 5A-FIG. 5F). Micro-scale and nano-scale basalt fibers coexisted in the composite, with the area fractions of the micro-scale fibers and the nano-scale fibers being 71.8% and 29.2%, respectively (FIG. 6A-FIG. 6H). The micro-scale fibers were primarily distributed at the grain boundaries, serving to pin the grain boundaries and refine the grains. The nano-scale fibers were primarily located inside the Al grains, providing an Orowan strengthening effect.

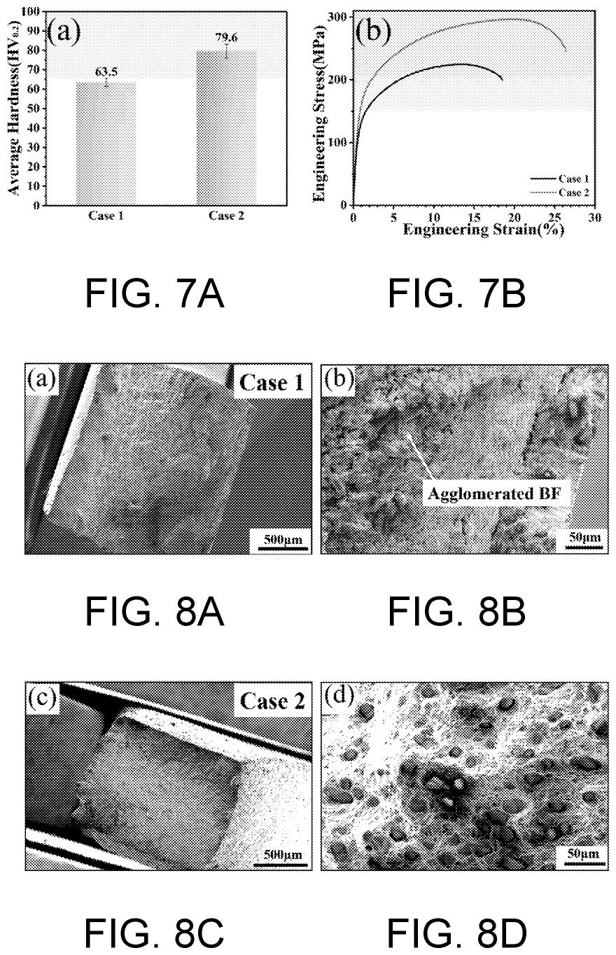

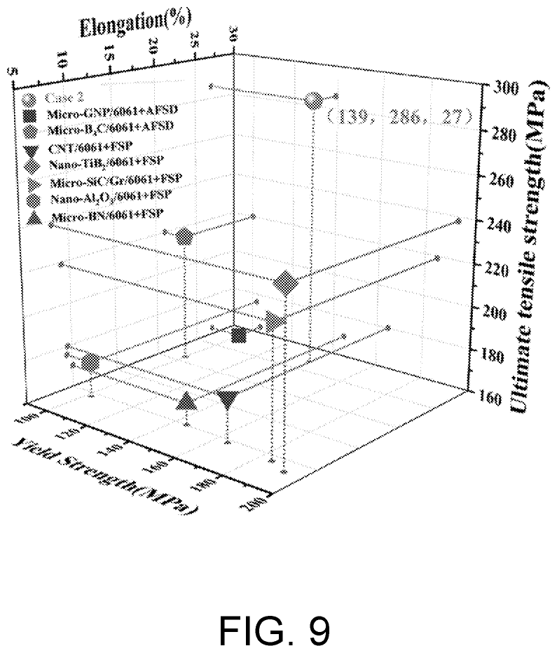

By comparing the mechanical properties of Case 1 and Case 2, it was found that the hardness, tensile strength, and elongation of the composite prepared with the pre-deposited layer were all significantly improved (FIG. 7A-FIG. 7B). The fracture characterization revealed that there was local fiber agglomeration in the fracture of Case 1 prepared without the pre-deposited layer, and the average length of the fibers reached 30 μm. This indicated insufficient fiber dispersion and fragmentation during the stirring process, which weakened the bonding effect between the fibers and the matrix in the composite, leading to reduced interfacial load transfer efficiency (FIG. 8A-FIG. 8D). Case 2 prepared with the pre-deposited layer exhibited a UTS of 286 MPa and an EI of 27%, which were equivalent to 95% and 208% of the corresponding properties of the feedstock rod, respectively, indicating that the composite could achieve a significant improvement in plasticity while maintaining its strength. It was found that this sample had the highest UTS value compared with other 6061 aluminum matrix composites prepared using similar processes (AFSD, FSP) (FIG. 9). It should be noted that the BF/AA6061 composite obtained in this example was a multi-scale metal matrix composite prepared by adding a millimeter-scale (about 3 mm) reinforcement, and the raw material cost was greatly reduced compared with the control group (where the reinforcement was at the micro-or nano-scale).

### Example 2

Using the same basalt fibers and aluminum alloy raw materials as in Example 1, based on the obtained single-pass BF/AA6061 composite, multi-pass deposition was further performed according to a designed path, thereby enabling synchronous integration of the preparation and forming of the novel composite.

It should be understood that those of ordinary skill in the art can make improvements or modifications based on the above description, and all such improvements and modifications shall fall within the protection scope of the appended claims of the present disclosure.

What is claimed is:

1. A preparation method for a multi-scale fiber reinforced aluminum matrix composite based on solid-state additive manufacturing, comprising the following steps:
S1, preparing an aluminum alloy solid square bar, an aluminum alloy hollow square bar, an aluminum alloy substrate of the same material, and short basalt fibers, and subjecting the short basalt fibers to cleaning with distilled water, drying, and removal of impurities and dirt for later use;
S2, weighing a certain mass of the basalt fibers and loading them into the hollow square bar in a random orientation manner;
S3, capping the hollow square bar filled with the basalt fibers with small AA6061 stubs to maintain the content of the fibers, followed by vibration to promote dispersion of the fibers;
S4, loading the solid square bar into an AFSD apparatus and performing single-pass deposition on the substrate to prepare a “pre-deposited layer”;
S5, measuring the thickness of the pre-deposited layer and correspondingly raising the initial height of an AFSD tool head;
S6, loading the hollow square bar filled with the basalt fibers and performing single-pass deposition again on the pre-deposited layer using the same process parameters as in S4; and
S7, cutting off the substrate and the underlying pre-deposited layer of a sample obtained in S6, while retaining only the uppermost deposited layer, thereby obtaining the multi-scale basalt fiber reinforced aluminum matrix composite.

2. The preparation method according to claim 1, wherein in step S1, the aluminum alloy may be an aluminum alloy of 7xxx, 6xxx, 5xxx, or 2xxx series.

3. The preparation method according to claim 1, wherein in step S1, the basalt fibers are short-cut basalt fibers, with a length of 1-3 mm and an average diameter of 10-20 μm.

4. The preparation method according to claim 1, wherein in step S1, a hollow region of the square bar may be cylindrical or cubic, and the volume of the hollow region accounts for 3%-10% of that of the square bar.

5. The preparation method according to claim 1, wherein in step S2, the loading mass of the fibers is calculated according to formula (1), wherein A is a coefficient with a value between 30% and 50%;
m_{fiber}=ρ_{fiber}×ν_{fiber}=ρ_{fiber}×ν_{hollow}×A (1)

6. The preparation method according to claim 1, wherein in step S3, in order to promote the dispersion of the fibers in the bar, a mechanical vibration, centrifugal dispersion, or ultrasonic dispersion method is adopted.

7. The preparation method according to claim 1, wherein in step S4, the process parameters for the deposition process are a preheating time of 10-20 s, a tool head feeding speed of 40-50 mm/min, a traversing speed of 100-120 mm/min, and a rotating speed of 300-500 rpm.

8. The preparation method according to claim 1, wherein in step S5, the thickness of the pre-deposited layer is controlled to be between 2 mm and 4 mm.

9. The preparation method according to claim 1, wherein in step S6, based on an obtained single-pass BF/AA6061 composite, multi-pass deposition can be further performed according to a designed path, thereby enabling synchronous integration of the preparation and forming of the novel composite.

10. A multi-scale fiber reinforced aluminum matrix composite prepared by the method according to any one of claim 1.
